(19) United States
(12) Patent Application Publication
(10) Pub. No.: US 2020/0180636 A1
(43) Pub. Date: Jun. 11, 2020

(54) APPARATUS AND METHOD FOR CONTROLLING RUNNING OF VEHICLE

(71) Applicants: HYUNDAI MOTOR COMPANY, Seoul (KR); KIA MOTORS CORPORATION, Seoul (KR)

(72) Inventors: Young Chul OH, Seongnam-si (KR); Ki Cheol SHIN, Seongnam-si (KR); Seong Su IM, Suwon-si (KR)

(73) Assignees: HYUNDAI MOTOR COMPANY, Seoul (KR); KIA MOTORS CORPORATION, Seoul (KR)

(21) Appl. No.: 16/456,380

(22) Filed: Jun. 28, 2019

(30) Foreign Application Priority Data
Dec. 7, 2018 (KR) 10-2018-0157376

(51) Int. Cl. B60W 30/18; B60Q 1/34; B60W 30/095; B60W 30/09

(52) U.S. Cl. CPC B60W 30/18163; B60Q 1/346; B60W 30/0953; B60W 2720/106; B60W 2550/306; B60W 2550/302; B60W 2550/304; B60W 30/09

(57) ABSTRACT

A vehicle running control method includes: determining whether a host vehicle in a traveling lane enters the junction section during autonomous traveling; collecting environment information of at least one vehicle adjacent to the host vehicle upon determining that the host vehicle enters the junction section; determining whether the traveling lane and the target lane are congested using the collected environment information; upon determining that the traveling lane and the target lane are congested, estimating a cut-in point of a preceding vehicle and determining a target point of the target lane from the estimated cut-in point; generating a cut-in path to the determined target point and displaying an intention to change lanes; and determining whether a rear approaching vehicle has the intention to yield and performing the lane change according to the result of the determination.

### CROSS REFERENCE TO RELATED APPLICATION

This application claims priority to and the benefit of Korean Patent Application No. 10-2018-0157376, filed on Dec. 7, 2018, the entire contents of which are incorporated herein by reference.

### FIELD

The present disclosure relates to an apparatus and method for controlling the running of an autonomous vehicle that are capable of changing lanes in a junction section.

### BACKGROUND

The statements in this section merely provide background information related to the present disclosure and may not constitute prior art.

Conventional lane changing technology is merely configured such that, when a driver shows his/her intention to change lanes (for example, when the driver turns on a turn signal lamp), it is determined whether it is possible to change lanes within a predetermined time, and the lane change is performed upon determining that it is possible to change lanes.

Additionally, in most research on autonomous traveling, the lane change is performed only when it is possible to change lanes, for example, when a route that makes it possible to avoid a collision is generated. Furthermore, level-4 autonomous traveling must be designed such that traveling is possible from the current position to a destination without the intervention of a driver under limited operational design domain (ODD) conditions, unlike level-2 autonomous traveling (ADAS system). Therefore, the conventional lane-changing technology has difficulty in satisfying the requirements of the level-4 autonomous traveling.

Particularly, we have found that it is not possible to change lanes on a merging road, which is congested with vehicles, using a conventional traveling strategy that determines only the degree of danger. Therefore, a positive lane-change strategy capable of predicting the traveling pattern of adjacent vehicles and inducing yielding of the adjacent vehicles through the behavior of a host vehicle is required.

### SUMMARY

Accordingly, the present disclosure is directed to a vehicle running control apparatus and method that substantially obviate one or more problems due to limitations and disadvantages of the related art.

The present disclosure provides a vehicle running control apparatus and method that are capable of predicting a cut-in point of a preceding vehicle and controlling the velocity of a vehicle to a velocity corresponding to the flow of adjacent vehicles at the time of attempting a lane change in a junction section that is congested with vehicles.

Objects of the present disclosure devised to solve the problems are not limited to the aforementioned object, and other unmentioned objects will be clearly understood by those skilled in the art based on the following detailed description of the present disclosure.

To achieve these objects and other advantages and in accordance with the purpose of the present disclosure, as embodied and broadly described herein, a vehicle running control method includes: determining, by a lane-change recognition unit, whether a host vehicle in a traveling lane enters the junction section during autonomous traveling; collecting, by the lane-change recognition unit, environment information of at least one vehicle adjacent to the host vehicle upon determining that the host vehicle enters the junction section; determining, by the lane-change recognition unit, whether the traveling lane and the target lane are congested using the collected environment information; upon determining that the traveling lane and the target lane are congested, estimating, by a path generation unit, a cut-in point of a preceding vehicle and determining a target point of the target lane from the estimated cut-in point; generating, by the path generation unit, a cut-in path to the determined target point and displaying an intention to change lanes; and determining, by a danger-degree determination unit, whether a rear approaching vehicle has the intention to yield and performing the lane change based on determination of the intention of the rear approaching vehicle.

The step of collecting the environment information may include collecting the position, the velocity, and the acceleration of at least one vehicle adjacent to the host vehicle through a sensor.

The step of determining whether the traveling lane and the target lane are congested may include calculating a first velocity flow, which is the average velocity of the preceding vehicle traveling in the traveling lane, calculating a second velocity flow, which is acquired by applying a predetermined weight to the average velocity of the at least one vehicle traveling in the target lane, and determining that the traveling lane and the target lane are congested when each of the calculated first velocity flow and the second velocity flow is less than a critical value.

The step of estimating the cut-in point of the preceding vehicle may include detecting the behavior of the preceding vehicle through the sensor and estimating the cut-in point of the preceding vehicle based on at least one of the longitudinal velocity or the lateral velocity of the preceding vehicle based on detected behavior information of the preceding vehicle.

When no lateral behavior of the preceding vehicle is detected, the position calculated based on the time for the preceding vehicle to arrive at a position between target lane vehicles and the longitudinal velocity of the preceding vehicle may be estimated as the cut-in point of the preceding vehicle.

When the lateral behavior of the preceding vehicle is detected, a position calculated based on the time for the preceding vehicle to enter the target lane and the lateral velocity and the longitudinal velocity of the preceding vehicle defined by a direction in which the preceding vehicle is advancing may be estimated as the cut-in point of the preceding vehicle.

The step of determining the target point may include: calculating positions of target lane vehicles based on the environment information; selecting a vehicle corresponding to the estimated cut-in point, among the target lane vehicles, as a target vehicle; searching for a rear approaching vehicle behind the selected target vehicle; and determining the position of an area in which a safe distance is secured between the target vehicle and the rear approaching vehicle to be the target point, and wherein the target vehicle may be a rear vehicle selected among a front vehicle and a rear vehicle defined by the cut-in point.

The cut-in path may be a traveling path in which the host vehicle deviates toward the target point, and the step of displaying the intention to change lanes may include decelerating the host vehicle along the generated cut-in path and turning on a turn signal lamp of the host vehicle.

The step of determining whether the rear approaching vehicle has the intention to yield may include determining whether the time to be taken for the host vehicle to collide with the rear approaching vehicle (time to collision) exceeds a predetermined critical value, and the host vehicle may be stopped when the time to collision exceeds the predetermined critical value, whereas the lane change may be performed when the time to collision is equal to or less than the predetermined critical value.

In another form of the present disclosure, a vehicle running control apparatus for changing a lane to a target lane at a time of entry into a junction section may comprises one or more processors configured to: determine whether a host vehicle in a traveling lane enters the junction section during autonomous traveling, collect environment information of at least one vehicle adjacent to the host vehicle upon determining that the host vehicle enters the junction section, determine whether the traveling lane and the target lane are congested using the collected environment information, estimate a cut-in point of a preceding vehicle upon determining that the traveling lane and the target lane are congested, determine a target point of the target lane from the estimated cut-in point, generate a cut-in path to the determined target point, decelerate the host vehicle to a predetermined first velocity along the cut-in path, determine whether a rear approaching vehicle has an intention to yield, and perform the lane change based on determination of the intention of the rear approaching vehicle.

It is to be understood that both the foregoing general description and the following detailed description of the present disclosure are exemplary and explanatory and are intended to provide further explanation of the present disclosure as claimed.

Further areas of applicability will become apparent from the description provided herein. It should be understood that the description and specific examples are intended for purposes of illustration only and are not intended to limit the scope of the present disclosure.

### DRAWINGS

The accompanying drawings, which are included to provide a further understanding of the present disclosure and are incorporated in and constitute a part of this application, illustrate form(s) of the present disclosure and together with the description serve to explain the principle of the present disclosure.

In order that the disclosure may be well understood, there will now be described various forms thereof, given by way of example, reference being made to the accompanying drawings, in which:

FIG. 1 is a schematic block diagram showing an autonomous vehicle according to one form of the present disclosure;

FIG. 2 is a view illustrating a second velocity flow in a target lane related to one form of the present disclosure;

FIG. 3 is a view illustrating a method of estimating a cut-in point of a preceding vehicle according to an exemplary form of the present disclosure;

FIG. 4 is a view illustrating a method of estimating a cut-in point of a preceding vehicle according to another form of the present disclosure;

FIG. 5 is a view illustrating a method of controlling the velocity of a host vehicle when the host vehicle reaches the end point of a junction section according to one form of the present disclosure; and

FIG. 6 is a flowchart illustrating a vehicle running control method according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Since the forms of the present disclosure may be variously modified and may have various forms, specific forms will be shown in the drawings and will be described in detail in this specification or this disclosure. However, the forms according to the concept of the present disclosure are not limited by such specific forms, and it should be understood that the present disclosure includes all alterations, equivalents, and substitutes that fall within the idea and technical scope of the present disclosure.

It will be understood that, although the terms “first”, “second”, etc. may be used herein to describe various elements, the corresponding elements should not be understood to be limited by these terms, which are used only to distinguish one element from another. In addition, the terms particularly defined in consideration of the constructions and operations of the forms are provided to explain the forms, rather than to limit the scope of the forms.

The terms used in this specification are provided only to explain specific forms, but are not intended to restrict the present disclosure. A singular representation may include a plural representation unless it represents a definitely different meaning from the context. It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof.

Unless otherwise defined, all terms, including technical and scientific terms, used in this specification have the same meaning as commonly understood by a person having ordinary skill in the art to which the present disclosure pertains. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Hereinafter, a vehicle running control apparatus according to exemplary forms of present disclosure will be described with reference to the accompanying drawings. First of all, the principal terms used in this specification and the drawings is described as follows:

Host vehicle: Subject vehicle,

Adjacent vehicles: Vehicles other than the host vehicle that are detected by a sensor unit mounted in the host vehicle,

Preceding vehicle: Adjacent vehicle that travels ahead of the host vehicle,

Traveling lane: Lane in which the host vehicle is traveling,

Target lane: Lane that the host vehicle attempts to enter,

Target lane vehicles: Adjacent vehicles that are traveling in the target lane.

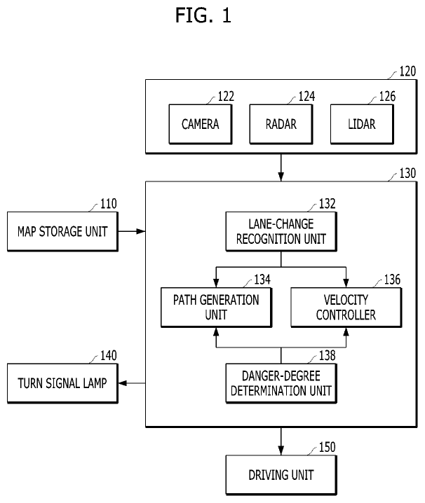

FIG. 1 is a schematic block diagram showing an autonomous vehicle according to one form of the present disclosure

As shown in FIG. 1, the autonomous vehicle, denoted by reference numeral 100, may include a map storage unit 110, a sensor unit 120, a vehicle running control apparatus 130, a turn signal lamp 140, and a driving unit 150.

Here, the terms, such as ‘unit’ ‘controller’ or ‘module’, etc., should be understood as a unit that processes at least one function or operation and that may be embodied in a hardware manner (e.g., a processor), a software manner, or a combination of the hardware manner and the software manner.

The map storage unit 110 may store information about a high-definition map, from which it is possible to distinguish between vehicle lanes, in the form of a database (DB). The high-definition map may be automatically and periodically updated through wireless communication, or may be manually updated by a user, and may include lane-based junction section information (including, for example, information about the positions of junction sections and information about the legal maximum velocity of each junction section), position-based road information, road divergence information, and intersection information.

The map storage unit 110 may be implemented as at least one of flash memory, a hard disk, a secure digital (SD) card, random access memory (RAM), read only memory (ROM), or web storage.

The sensor unit 120 may acquire information about the environment around a host vehicle, and may recognize one or more adjacent vehicles located within a detection range RF.

The sensor unit 120 may sense one or more adjacent vehicles located ahead of, beside, and behind the host vehicle, and may detect the position, the velocity, and the acceleration of each of the adjacent vehicles.

The sensor unit 120 may include a camera 122, a radar 124, and a LiDAR 126, which are mounted to the front, the side, and the rear of the host vehicle.

The camera 122 may acquire images of the surroundings of the host vehicle through an image sensor. The camera may include an image processor for performing image processing, such as noise removal, quality and saturation adjustment, and file compression, with respect to the acquired images.

The radar 124 may measure the distance between the host vehicle and adjacent vehicles. The radar 124 may emit electromagnetic waves to the adjacent vehicles and may receive the electromagnetic waves reflected by the adjacent vehicles in order to acquire the distance from each of the adjacent vehicles, the direction of each of the adjacent vehicles, and the altitude of each of the adjacent vehicles.

The LiDAR 126 may measure the distance between the host vehicle and the adjacent vehicles. The LiDAR 126 may emit laser pulses to the adjacent vehicles and may measure the arrival time of each of the laser pulses reflected by the adjacent vehicles to calculate the spatial positional coordinates of the reflection points, thereby acquiring the distance from each of the adjacent vehicles and the shape of each of the adjacent vehicles.

The vehicle running control apparatus 130 may receive the lane-based junction section information, included in the high-definition map, from the map storage unit 110, and may determine whether a host vehicle in a traveling lane enters a junction section.

The vehicle running control apparatus 130 may receive environment information of one or more adjacent vehicles located within the detection range FR from the sensor unit 120. Here, the environment information may include the position, the velocity, and the acceleration of each of the adjacent vehicles. The vehicle running control apparatus 130 may determine whether the traveling lane and a target lane are congested based on the environment information of the adjacent vehicles received from the sensor unit 120.

Upon determining that the host vehicle in the traveling lane enters the junction section and that the traveling lane or the target lane is congested, the vehicle running control apparatus 130 may generate a cut-in path of the host vehicle based on the behavior of a preceding vehicle, and may control the velocity of the host vehicle based on the velocity flow of target lane vehicles.

In addition, the vehicle running control apparatus 130 may determine a degree of danger of a collision based on the behavior of the target lane vehicles, and may change lanes or stop the host vehicle according to the result of determination of the degree of danger of the collision.

The vehicle running control apparatus 130 may include a lane-change recognition unit 132, a path generation unit 134, a velocity controller 136, and a danger-degree determination unit 138.

The lane-change recognition unit 132 may determine whether the host vehicle in the traveling lane enters the junction section based on the lane-based junction section information received from the map storage unit 110.

When the host vehicle in the traveling lane enters the junction section, the lane-change recognition unit 132 may determine whether the traveling lane or the target lane is congested based on the environment information of the adjacent vehicles, received from the sensor unit 120.

In order to determine whether the traveling lane and the target lane are congested, the lane-change recognition unit 132 may calculate a first velocity flow in the traveling lane and a second velocity flow in the target lane, and may determine whether each the calculated first and second velocity flows is less than a critical value.

Here, the first velocity flow may mean the average velocity of one or more vehicles located ahead of the host vehicle among vehicles traveling in the traveling lane.

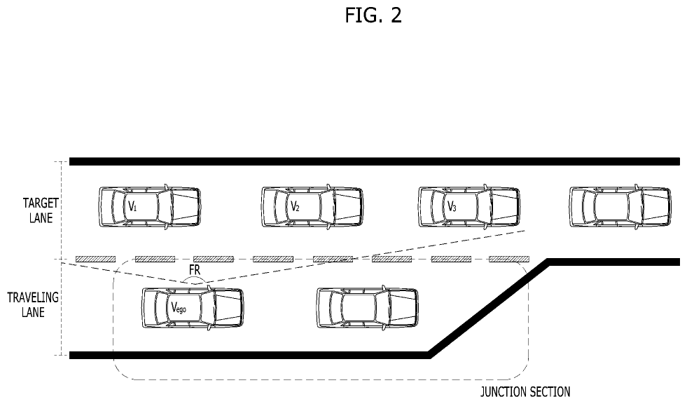

The second velocity flow may mean the average velocity of one or more vehicles located within the detection range FR of the sensor unit 120 among vehicles traveling in the target lane. For the second velocity flow, a predetermined weight may be applied to the average velocity in order to reduce or minimize errors due to inaccurate measurement of the sensor unit 120 or noise. The second velocity flow will be described in detail with reference to FIG. 2.

FIG. 2 is a view illustrating a second velocity flow in a target lane in one form of the present disclosure.

As shown in FIG. 2, when the host vehicle V_{ego} attempts to change lanes from the traveling lane to the left lane (in the direction in which the vehicle advances), a second velocity flow v_{b} in a target lane may be calculated using Equation 1.

$${v}_{b} = {v}_{m} + {\sum }_{i = 1}^{n} ( {v}_{i} - {v}_{m} ) {w}_{i} , ( {v}_{m} = \frac{1}{n} {\sum }_{i = 1}^{n} {v}_{i} ) \qquad [ Equation 1 ]$$

Here, vₘ is the average velocity of one or more vehicles V₁, V₂, and V₃ located within the detection range FR of the sensor unit 120 among vehicles traveling in the target lane, vᵢ is the velocity of an i-th target lane vehicle, wᵢ is a weight, which is a value arbitrarily defined by a developer (or a user), and n is the number of detected target lane vehicles.

The weight wᵢ, which is applied to the respective target lane vehicles V₁, V₂, and V₃, may include a value in which variation in the average velocity vₘ is reflected, and may be preset using a Gaussian function.

Meanwhile, in the case in which the host vehicle receives information about the velocity of each of the vehicles located ahead of the host vehicle through V2X (Vehicle to Everything) communication, the first velocity flow in the traveling lane may also be applied in the same manner as in the method of calculating the second velocity flow to which the predetermined weight is applied.

Referring back to FIG. 1, in the case in which the calculated first and second velocity flows are less than the critical value, the lane-change recognition unit 132 may transmit a predetermined trigger signal to the path generation unit 134 and the velocity controller 136.

Here, the critical value is a predetermined reference value based on which it is determined whether the traveling lane and the target lane are congested, and may have a range of about 20 kph to 30 kph. However, the critical value may differ depending on the road (for example, whether the road is an expressway or a general public road), and does not need to be limited to the above range.

In addition, the trigger signal may be a control signal for changing the lane in which the host vehicle travels from the traveling lane to the target lane.

Upon receiving the trigger signal from the lane-change recognition unit 132, the path generation unit 134 may generate a cut-in path of the host vehicle based on the behavior of the preceding vehicle.

The path generation unit 134 may estimate a cut-in point of the preceding vehicle, may determine a target point of the target lane from the estimated cut-in point, and may generate a cut-in path to the determined target point.

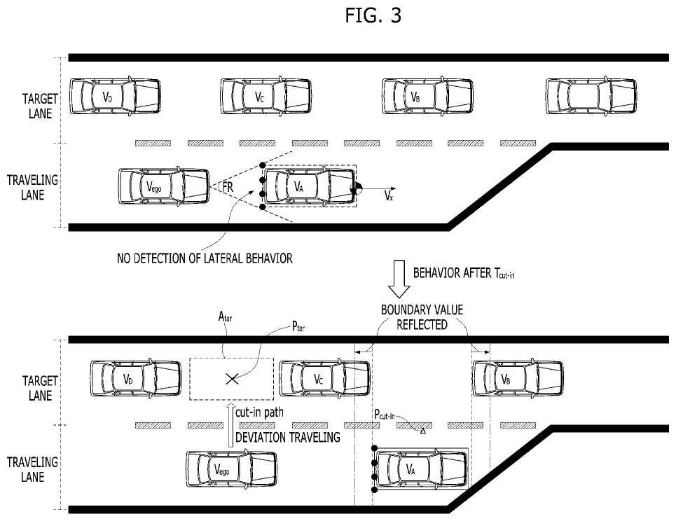

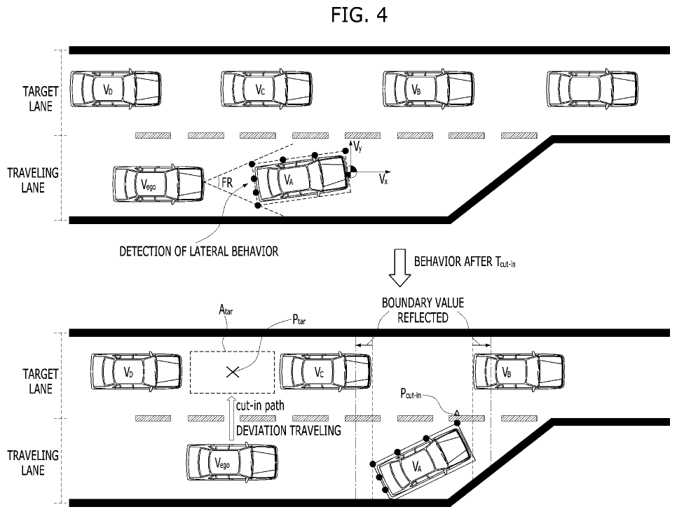

The path generation unit 134 may detect the behavior of the preceding vehicle through the sensor unit 120, and may estimate the cut-in point of the preceding vehicle based on at least one of the longitudinal velocity or the lateral velocity of the preceding vehicle according to the result of the detection. This will be described hereinafter in detail with reference to FIGS. 3 and 4.

FIG. 3 is a view illustrating a method of estimating a cut-in point of a preceding vehicle according to another form of the present disclosure.

As shown in FIG. 3, in the case in which the lateral behavior of a preceding vehicle V_{A} is not detected, the path generation unit 134 may estimate a position P_{cut-in}, calculated based on the time t_{cut-in} desired for the preceding vehicle V_{A} to arrive at a position between target lane vehicles V_{B} and V_{C} and the longitudinal velocity vₓ of the preceding vehicle V_{A}, as a cut-in point of the preceding vehicle V_{A}.

The path generation unit 134 may perform modeling based on the image of the preceding vehicle V_{A} acquired through the sensor unit 120 and may extract a plurality of feature points in order to calculate the longitudinal velocity vₓ of the preceding vehicle V_{A}.

Meanwhile, the cut-in point may be estimated by reflecting a predetermined boundary value, set in consideration of accuracy in the measurement of the sensor unit 120, the overall length of each of the preceding vehicle V_{A} and the target lane vehicles V_{B} and V_{C}, or the driving tendency of a driver (for example, the aggressive driving tendency of the driver), in the calculated position P_{cut-in}. Here, the predetermined boundary value may be preset as a margin defined by a developer.

FIG. 4 is a view illustrating a method of estimating a cut-in point of a preceding vehicle according to another form of the present disclosure.

As shown in FIG. 4, in the case in which the lateral behavior of a preceding vehicle V_{A} is detected, the path generation unit 134 may estimate a position P_{cut-in}, calculated based on the time t_{cut-in} desired for the preceding vehicle V_{A} to enter a target lane and the lateral velocity v_{y} and the longitudinal velocity vₓ of the preceding vehicle V_{A} in the direction in which the preceding vehicle V_{A} is advancing, as a cut-in point of the preceding vehicle V_{A}.

The path generation unit 134 may perform modeling based on the image of the preceding vehicle V_{A} acquired through the sensor unit 120, may extract a plurality of feature points, and may calculate the lateral velocity v_{y} of the preceding vehicle V_{A} using the movement value of the leftmost point corresponding to the heading direction of the preceding vehicle V_{A}.

Meanwhile, the cut-in point may be estimated by reflecting a predetermined boundary value, set in consideration of accuracy in the measurement of the sensor unit 120, the overall length of each of the preceding vehicle V_{A} and the target lane vehicles V_{B} and V_{C}, or the driving tendency of a driver (for example, the aggressive driving tendency of the driver), in the calculated position P_{cut-in}. Here, the predetermined boundary value may be preset as a margin defined by a developer.

The path generation unit 134 may determine a target point in the target lane from the estimated cut-in point of the preceding vehicle.

Referring to FIGS. 3 and 4, the path generation unit 134 may calculate the position of each of the target lane vehicles based on the environment information acquired from the sensor unit 120, may select a vehicle corresponding to the estimated cut-in point, among target lane vehicles V_{B} and V_{C}, as a target vehicle V_{C}, may search for a rear approaching vehicle V_{D} behind the target vehicle V_{C}, and may determine the position of an area Aₜₐᵣ in which the safe distance is secured between the target vehicle V_{C} and the rear approaching vehicle V_{D} to be a target point Pₜₐᵣ. Here, the target vehicle means the rear vehicle V_{C}, among the front vehicle V_{B} and the rear vehicle V_{C} defined by the cut-in point P_{cut-in}.

The path generation unit 134 may generate a cut-in path to the determined target point Pₜₐᵣ. Here, the cut-in path may be a traveling path in which the host vehicle V_{ego} deviates toward the target point Pₜₐᵣ.

Referring back to FIG. 1, the velocity controller 136 may perform control to reduce the velocity of the host vehicle V_{ego} to a first velocity v_{d} calculated based on predetermined velocity information along the cut-in path, generated by the path generation unit 134. Here, the first velocity v_{d} means the minimum movement velocity desired for the host vehicle V_{ego} to perform the lane change.

The velocity controller 136 may receive the legal maximum velocity (for example, the maximum limit velocity) of the lane-based junction section, stored in the map storage unit 110, and may receive the calculated second velocity flow v_{b} in the target lane from the lane-change recognition unit 132.

The velocity controller 136 may compare the legal maximum velocity v_{c} of the junction section, received from the map storage unit 110, with the second velocity flow v_{b} in the target lane, received from the lane-change recognition unit 132, and may set the minimum value thereof, i.e. the first velocity v_{d}, as the control velocity of the host vehicle V_{ego}. Here, the first velocity v_{d} as may be calculated using Equation 2.

v_{d}=min[v_{b},v_{c}] [Equation 2]

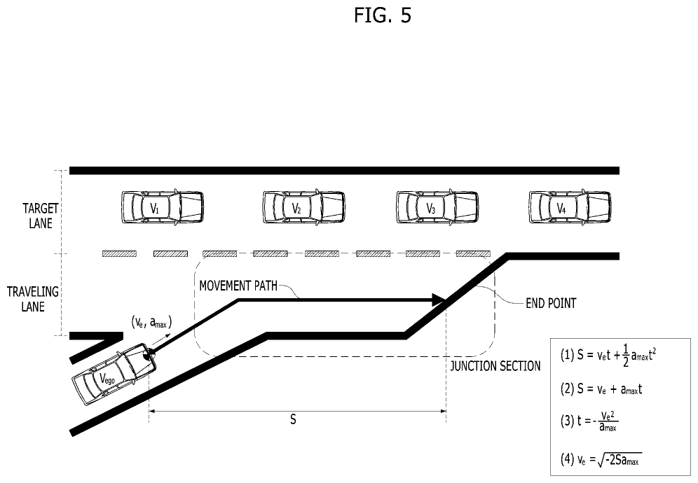

Meanwhile, in the case in which rear approaching vehicles have no intention to yield or in which the host vehicle V_{ego} enters the junction section at a velocity that is too high due to the characteristics of the junction section, which has the end point, there is the possibility of a collision at the end point of the junction section. In the case in which it is predicted that the host vehicle will reach the end point of the junction section, therefore, it is desired for the velocity controller 136 to control the host vehicle V_{ego} such that the host vehicle V_{ego} travels at a specific velocity. This will be described with reference to FIG. 5.

FIG. 5 is a view illustrating a method of controlling the velocity of the host vehicle when the host vehicle reaches the end point of the junction section according to one form of the present disclosure.

Referring to FIG. 5, in the case in which the host vehicle V_{ego} reaches the end point of the junction section (for example, in the case in which the target lane vehicles have no intention to yield), the velocity controller 136 may perform control such that the velocity of the host vehicle is reduced to a second velocity vₑ, which is the maximum stop velocity calculated in consideration of the riding comfort of a user, or such that the host vehicle is stopped (or braked).

The predetermined second velocity vₑ may be calculated using Equation 3.

vₑ=\sqrt{−2Saₘₐₓ},(aₘₐₓ<0) [Equation 3]

Here, S is the distance between the current position and the end point of the junction section, aₘₐₓ is the maximum deceleration considering the riding comfort of the user on the assumption that the host vehicle is stopped at the end point of the junction section, and vₑ is the maximum stop velocity based on uniform acceleration movement.

In the case which the first velocity v_{d}, which is the minimum movement velocity desired for the host vehicle V_{ego} to perform a lane change, is higher than the second velocity vₑ, which is the maximum stop velocity, the velocity controller 136 may perform control such that the host vehicle V_{ego} is stopped (or braked). This is desired to protect the user from a collision due to the characteristics of the junction section, which has the end point.

Referring back to FIG. 1, the danger-degree determination unit 138 may determine whether the rear approaching vehicle V_{D} has the intention to yield. The intention to yield may be determined based on whether the time to collision TTC with the rear approaching vehicle V_{D} exceeds a predetermined critical value.

The time to collision TTC means the time to be taken for the host vehicle V_{ego} to collide with the rear approaching vehicle V_{D} in consideration of the relative position, the relative velocity, and the relative acceleration of the rear approaching vehicle V_{D} in the case in which the current state is maintained.

In the case in which the time to collision TTC exceeds the predetermined critical value, the host vehicle may be stopped. In the case in which the time to collision TTC is equal to or less than the predetermined critical value, the lane change may be performed.

When the vehicle running control apparatus 130 generates the cut-in path of the host vehicle V_{ego}, the turn signal lamp 140 may be turned on. After the lane change is performed, the turn signal lamp 140 may be turned off. However, this is merely illustrative. Turning on and off of the turn signal lamp 140 are not limited thereto.

The driving unit 150 is configured to drive the host vehicle V_{ego} in response to a control signal from the velocity controller 136, and may include components for actually driving the vehicle, such as a brake, an accelerator, a transmission, and a steering device.

For example, in the case in which the control signal from the velocity controller 136 is a signal indicating a lane change to the left lane (for example, to the target lane) with deceleration, the brake of the driving unit 150 may perform a deceleration operation, and the steering device may apply torque in the leftward direction.

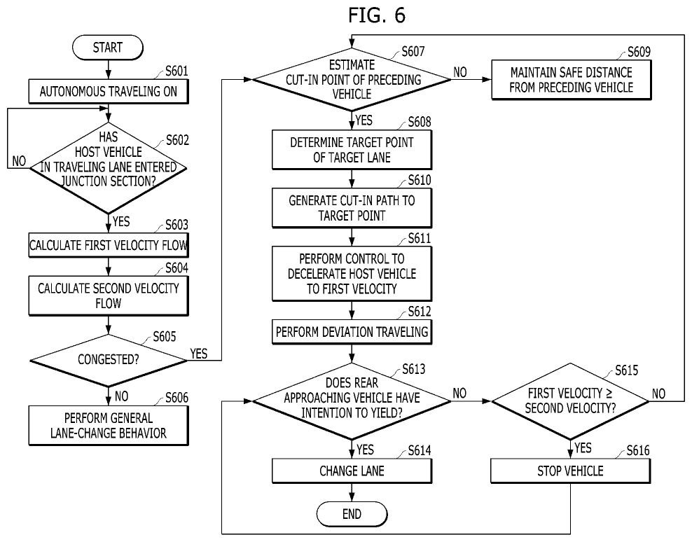

Hereinafter, a vehicle running control method for changing the lane to the target lane at the time of entry into the junction section will be described with reference to FIG. 6.

FIG. 6 is a flowchart illustrating a vehicle running control method according to one form of the present disclosure.

As shown in FIG. 6, when autonomous traveling is performed (S601), the lane-change recognition unit 132 may determine whether the host vehicle in the traveling lane enters the junction section based on the lane-based junction section information received from the map storage unit 110 (S602).

When the host vehicle in the traveling lane enters the junction section (YES in S602), the lane-change recognition unit 132 may calculate a first velocity flow in the traveling lane and a second velocity flow in the target lane based on the environment information of the adjacent vehicles received from the sensor unit 120 (S603 and S604). Here, the first velocity flow may mean the average velocity of one or more vehicles located ahead of the host vehicle among the vehicles traveling in the traveling lane. The second velocity flow may mean the average velocity of one or more vehicles located within the detection range FR of the sensor unit 120 among the vehicles traveling in the target lane. For the second velocity flow, a predetermined weight may be applied to the average velocity in order to reduce or minimize errors due to inaccurate measurement of the sensor unit 120 or noise.

The lane-change recognition unit 132 may determine whether the traveling lane and the target lane are congested based on whether each of the calculated first and second velocity flows is less than a critical value (S605).

Upon determining that the traveling lane and the target lane are not congested (NO in S605), general lane-change behavior may be performed (S606).

Upon determining that the traveling lane and the target lane are congested (YES in S605), the path generation unit 134 may estimate a cut-in point of the preceding vehicle (S607), may determine a target point of the target lane from the estimated cut-in point (S608), and may generate a cut-in path to the determined target point (S610).

In the case in which the cut-in point of the preceding vehicle is not estimated as the result of the determination at step S607, the host vehicle may move while being spaced apart from the preceding vehicle by a safe distance (S609).

After step S610, the velocity controller 136 may perform control to reduce the velocity of the host vehicle to a first velocity, calculated based on predetermined velocity information along the cut-in path, generated by the path generation unit 134 (S611), and may perform control such that the host vehicle travels while deviating toward the target point (S612). Here, the first velocity means the minimum movement velocity desired for the host vehicle to perform the lane change.

Subsequently, the danger-degree determination unit 138 may determine whether the rear approaching vehicle has the intention to yield (S613). The intention to yield may be determined based on whether the time to collision TTC with the rear approaching vehicle exceeds a predetermined critical value.

In the case in which the rear approaching vehicle has the intention to yield (YES in S613), the lane change may be performed, and the vehicle running control method may be finished (S614).

Meanwhile, in the case in which the rear approaching vehicle has no intention to yield (NO in S613), a second velocity, which is the maximum stop velocity calculated in consideration of the riding comfort of a user, and a first velocity, which is the minimum movement velocity desired for the host vehicle to perform the lane change, may be compared with each other (S615).

In the case in which the first velocity is equal to or higher than the second velocity (YES in S615), the velocity controller 136 may transmit a control signal for stopping (or braking) the host vehicle to the driving unit 150 (S616). At this time, the procedure may return to step S613 such that the danger-degree determination unit 138 determines whether the rear approaching vehicle has the intention to yield.

In the case in which the first velocity is lower than the second velocity (NO in S615), the procedure may return to step S607 such that the path generation unit 134 estimates the cut-in point of the preceding vehicle.

The vehicle running control method according to the exemplary forms of the present disclosure described above may be implemented as a program that can be executed by a computer and stored in a computer-readable recording medium. Examples of the computer-readable recording medium include ROM, RAM, CD-ROM, magnetic tape, a floppy disk, and an optical data storage device.

The computer-readable recording medium may be distributed to a computer system connected over a network, and computer-readable code may be stored and executed thereon in a distributed manner. Functional programs, code, and code segments for implementing the method described above may be easily inferred by programmers in the art to which at least one form pertains.

Although only a few forms have been described above, various other forms may be provided. The above forms may be combined in various manners unless they are incompatible, and new forms may be realized therethrough.

As is apparent from the above description, according to at least one form of the present disclosure, it is possible to predict a cut-in point of a preceding vehicle and to control the velocity of a host vehicle to a velocity corresponding to the flow of adjacent vehicles when the host vehicle travels in a lane having a junction section, whereby it is possible to provide a user with sufficient time for a user to smoothly change lanes.

In addition, it is possible to predict the cut-in point of the preceding vehicle based only on the longitudinal velocity thereof, whereby it is possible to respond to the traveling intention of the preceding vehicle.

It will be appreciated by those skilled in the art that the effects achievable through the present disclosure are not limited to what have been particularly described hereinabove and that other effects of the present disclosure will be more clearly understood from the above detailed description.

It will be apparent to those skilled in the art that various modifications and variations can be made in the present disclosure without departing from the spirit or scope of the present disclosure. Consequently, the above detailed description is not to be construed as limiting the present disclosure in any aspect, and is to be considered by way of example. The scope of the present disclosure should be determined by reasonable interpretation of the accompanying claims, and all equivalent modifications made without departing from the scope of the present disclosure should be understood to be included in the scope of the following claims.

What is claimed is:

1. A vehicle running control method for changing a lane to a target lane at a time of entry into a junction section, the vehicle running control method comprising:
determining, by a lane-change recognition unit, whether a host vehicle in a traveling lane enters the junction section during autonomous traveling;
collecting, by the lane-change recognition unit, environment information of at least one vehicle adjacent to the host vehicle upon determining that the host vehicle enters the junction section;
determining, by the lane-change recognition unit, whether the traveling lane and the target lane are congested using the collected environment information;
upon determining that the traveling lane and the target lane are congested, estimating, by a path generation unit, a cut-in point of a preceding vehicle and determining a target point of the target lane from the estimated cut-in point;
generating, by the path generation unit, a cut-in path to the determined target point and displaying an intention to change lanes; and
determining, by a danger-degree determination unit, whether a rear approaching vehicle has an intention to yield and performing the lane change based on determination of the intention of the rear approaching vehicle.

2. The vehicle running control method according to claim 1, wherein collecting the environment information comprises: collecting a position, a velocity, and an acceleration of at least one vehicle adjacent to the host vehicle through a sensor.

3. The vehicle running control method according to claim 2, wherein determining whether the traveling lane and the target lane are congested comprises:
calculating a first velocity flow, which is an average velocity of the preceding vehicle traveling in the traveling lane;
calculating a second velocity flow, which is acquired by applying a predetermined weight to an average velocity of the at least one vehicle traveling in the target lane; and
determining that the traveling lane and the target lane are congested when each of the calculated first velocity flow and the second velocity flow is less than a critical value.

4. The vehicle running control method according to claim 1, wherein estimating the cut-in point of the preceding vehicle comprises:
detecting a behavior of the preceding vehicle through a sensor; and
estimating the cut-in point of the preceding vehicle based on at least one of a longitudinal velocity or a lateral velocity of the preceding vehicle based on detected behavior information of the preceding vehicle.

5. The vehicle running control method according to claim 4, wherein, when no lateral behavior of the preceding vehicle is detected, a position calculated based on a time for the preceding vehicle to arrive at a position between target lane vehicles and the longitudinal velocity of the preceding vehicle is estimated as the cut-in point of the preceding vehicle.

6. The vehicle running control method according to claim 4, wherein, when a lateral behavior of the preceding vehicle is detected, a position calculated based on a time for the preceding vehicle to enter the target lane, and the lateral velocity and the longitudinal velocity of the preceding vehicle defined by a direction in which the preceding vehicle is advancing is estimated as the cut-in point of the preceding vehicle.

7. The vehicle running control method according to claim 1, wherein
determining the target point comprises:
calculating positions of target lane vehicles based on the collected environment information,
selecting a vehicle corresponding to the estimated cut-in point, among the target lane vehicles, as a target vehicle,
searching for a rear approaching vehicle behind the selected target vehicle, and
determining a position of an area, in which a safe distance is secured between the target vehicle and the rear approaching vehicle, as the target point, and
wherein the target vehicle is a rear vehicle selected among a front vehicle and a rear vehicle defined by the cut-in point.

8. The vehicle running control method according to claim 1, wherein
the cut-in path is a traveling path in which the host vehicle deviates toward the target point, and
wherein displaying the intention to change lanes comprises: decelerating the host vehicle along the generated cut-in path, and turning on a turn signal lamp of the host vehicle.

9. The vehicle running control method according to claim 1, wherein
determining whether the rear approaching vehicle has the intention to yield comprises:
determining whether a time to be taken for the host vehicle to collide with the rear approaching vehicle (time to collision) exceeds a predetermined critical value, and
wherein the host vehicle is stopped when the time to collision exceeds the predetermined critical value, whereas the lane change is performed when the time to collision is equal to or less than the predetermined critical value.

10. The vehicle running control method according to claim 1, further comprising: determining whether to stop the host vehicle before performing the lane change,
wherein determining whether to stop the host vehicle comprises: stopping the host vehicle when a traveling velocity of the host vehicle is equal to or higher than a predetermined maximum stop velocity.

11. A vehicle running control apparatus for changing a lane to a target lane at a time of entry into a junction section, the vehicle running control apparatus comprising:
a lane-change recognition unit configured to:
determine whether a host vehicle in a traveling lane enters the junction section during autonomous traveling,
collect environment information of at least one vehicle adjacent to the host vehicle upon determining that the host vehicle enters the junction section, and
determine whether the traveling lane and the target lane are congested using the collected environment information;
a path generation unit configured to:
upon determining that the traveling lane and the target lane are congested, estimate a cut-in point of a preceding vehicle,
determine a target point of the target lane from the estimated cut-in point, and
generate a cut-in path to the determined target point;
a velocity controller configured to decelerate the host vehicle to a predetermined first velocity along the cut-in path; and
a danger-degree determination unit configured to determine whether a rear approaching vehicle has an intention to yield and to perform the lane change based on determination of the intention of the rear approaching vehicle.

12. The vehicle running control apparatus according to claim 11, wherein the environment information comprises a position, a velocity, and an acceleration of at least one vehicle adjacent to the host vehicle collected through a sensor.

13. The vehicle running control apparatus according to claim 12, wherein the lane-change recognition unit is configured to:
calculate a first velocity flow, which is an average velocity of the preceding vehicle traveling in the traveling lane,
calculate a second velocity flow, which is acquired by applying a predetermined weight to an average velocity of the at least one vehicle traveling in the target lane, and
determine that the traveling lane and the target lane are congested when each of the calculated first velocity flow and the second velocity flow is less than a critical value.

14. The vehicle running control apparatus according to claim 11, wherein the path generation unit is configured to:
detect a behavior of the preceding vehicle through a sensor, and
estimate the cut-in point of the preceding vehicle based on at least one of a longitudinal velocity or a lateral velocity of the preceding vehicle based on the detected behavior of the preceding vehicle.

15. The vehicle running control apparatus according to claim 14, wherein, when no lateral behavior of the preceding vehicle is detected, the path generation unit is configured to estimate a position calculated based on a time for the preceding vehicle to arrive at a position between target lane vehicles and the longitudinal velocity of the preceding vehicle as the cut-in point of the preceding vehicle.

16. The vehicle running control apparatus according to claim 14, wherein, when a lateral behavior of the preceding vehicle is detected, the path generation unit is configured to estimate a position calculated based on a time for the preceding vehicle to enter the target lane, and the lateral velocity and the longitudinal velocity of the preceding vehicle defined by a direction in which the preceding vehicle is advancing, and
wherein the estimated position by the path generation unit is set as the cut-in point of the preceding vehicle.

17. The vehicle running control apparatus according to claim 11, wherein
the path generation unit is configured to:
calculate positions of target lane vehicles based on the collected environment information,
select a vehicle corresponding to the estimated cut-in point, among the target lane vehicles, as a target vehicle,
search for a rear approaching vehicle behind the selected target vehicle, and
determine a position of an area, in which a safe distance is secured between the target vehicle and the rear approaching vehicle, as the target point, and
wherein the target vehicle is a rear vehicle selected among a front vehicle and a rear vehicle defined by the cut-in point.

18. The vehicle running control apparatus according to claim 11, wherein
the cut-in path is a traveling path in which the host vehicle deviates toward the target point, and
the vehicle running control apparatus turns on a turn signal lamp of the host vehicle when the cut-in path is generated.

19. The vehicle running control apparatus according to claim 11, wherein the danger-degree determination unit is configured to
determine whether a time to be taken for the host vehicle to collide with the rear approaching vehicle (time to collision) exceeds a predetermined critical value,
stop the host vehicle when the time to collision exceeds the predetermined critical value, and
perform the lane change when the time to collision is equal to or less than the predetermined critical value.

20. A vehicle running control apparatus for changing a lane to a target lane at a time of entry into a junction section, the vehicle running control apparatus comprising: one or more processors configured to:
determine whether a host vehicle in a traveling lane enters the junction section during autonomous traveling,
collect environment information of at least one vehicle adjacent to the host vehicle upon determining that the host vehicle enters the junction section,
determine whether the traveling lane and the target lane are congested using the collected environment information,
estimate a cut-in point of a preceding vehicle upon determining that the traveling lane and the target lane are congested,
determine a target point of the target lane from the estimated cut-in point,
generate a cut-in path to the determined target point,
decelerate the host vehicle to a predetermined first velocity along the cut-in path,
determine whether a rear approaching vehicle has an intention to yield, and
perform the lane change based on determination of the intention of the rear approaching vehicle.
